(19) United States
(12) Patent Application Publication
(10) Pub. No.: US 2026/0109113 A1
(43) Pub. Date: Apr. 23, 2026

(54) MATERIAL FEEDING METHOD FOR 3D PRINTER, AND RELATED DEVICE

(71) Applicant: SHANGHAI LUNKUO TECHNOLOGY CO., LTD., SHANGHAI (CN)

(72) Inventors: Hongbin CHEN, SHANGHAI (CN); Gushun CHEN, SHANGHAI (CN); Jianjia MA, SHANGHAI (CN)

(21) Appl. No.: 19/428,358

(22) Filed: Dec. 22, 2025

Related U.S. Application Data
(63) Continuation of application No. PCT/CN2024/079423, filed on Feb. 29, 2024.

(30) Foreign Application Priority Data
Jun. 21, 2023 (CN) 202310753124.6

(51) Int. Cl. B29C 64/336; B29C 64/118; B33Y 30/00; B33Y 50/02; G06F 3/0484

(52) U.S. Cl. CPC B29C 64/336; B29C 64/118; B33Y 30/00; B33Y 50/02; G06F 3/0484

(57) ABSTRACT

Provided in the present application are a material feeding method for a 3D printer, and a related device. The method includes: displaying at least one material trough set, and each of the at least one material trough set includes at least two material troughs, there is a replacement relationship between the material troughs in each material trough set, and the at least one material trough set includes a first material trough set; and if it is detected that a printing material in a first material trough in the first material trough set is used up, on the basis of the replacement relationship between the material troughs in the first material trough set, replacing the printing material in the first material trough with a printing material in a second material trough in the first material trough set to perform printing.

### CROSS-REFERENCE TO RELATED APPLICATIONS

This application is a continuation of International Patent Application No. PCT/CN2024/079423, filed on Feb. 29, 2024, which claims priority to Chinese Patent Application No. 202310753124.6, filed on Jun. 21, 2023. The disclosures of the aforementioned applications are hereby incorporated by reference in their entireties.

### FIELD

The present application relates to the technical field of 3D printing, and in particular, to a material replenishment method for a 3D printer and a related device thereof.

### BACKGROUND

A 3D printer, also known as a three-dimensional printer (3DP), is a type of machine using additive manufacturing technology, i.e., rapid prototyping technology, which constructs a three-dimensional object through layer-by-layer printing using bondable materials based on digital model files. The bondable material is a printing material, and the printing material is disposed in the material trough.

During the process of constructing a three-dimensional object by the 3D printer, if the printing material in a material trough is used up, new printing materials need to be manually replenished, which gives rise to inconvenience and poor user experience.

### SUMMARY

The present application provides a material replenishment method for a 3D printer and a related device thereof, which can achieve automatic material replenishment without manual intervention, thereby offering convenient and fast operation, good user experience, and high printing efficiency.

An embodiment of the present application discloses a material replenishment method for a 3D printer. The 3D printer is configured to be connected to an automatic feeding system provided with a plurality of material troughs, and the material replenishment method includes:
displaying at least one material trough set, where each of the at least one material trough set includes at least two material troughs, and a replacement relationship exists between the material troughs within each material trough set;
the at least one material trough set includes a first material trough set; and if a printing material in a first material trough within the first material trough set is detected to be used up, replacing, based on a replacement relationship between the material troughs within the first material trough set, the printing material in the first material trough with a printing material in a second material trough within the first material trough set for printing.

In the embodiments of the present application, the material trough set may be intuitively displayed, and a replacement relationship exists between the material troughs within each material trough set. In the case that the printing material in the first material trough is used up, the second material trough in the same first material trough set as the first material trough can automatically replenish the printing material. By implementing the embodiments of the present application, the 3D printer can achieve automatic material replenishment without manual intervention, thereby offering convenient and fast operation, good user experience, and high printing efficiency.

With reference to the first aspect, in a first possible implementation, displaying the at least one material trough set is in one embodiment implemented as:
displaying at least two material troughs and a replacement relationship between the material troughs in the at least two material troughs.

By implementing the embodiments of the present application, the user is allowed to intuitively view the material troughs in the material trough set, as well as the replacement relationship between the material troughs. Thus, the user can know which material trough provides subsequent printing material after the printing material in a material trough is used up, thereby avoiding the situation where replenishment errors can only be discovered by the user during the material replenishment of the 3D printer, which would result in damage to the printed object.

With reference to the first aspect, in a second possible implementation, the material replenishment method further includes:
displaying a replacement relationship editing interface of a target material trough set in response to a user selecting the target material trough set from the at least one material trough set.

In the embodiments of the present application, the replacement relationship editing interface of the target material trough set is provided to the user. In this case, the user can edit the replacement relationship between the material troughs within the target material trough set on the replacement relationship editing interface. In addition, the replacement relationship editing interface may be displayed before or during printing. By implementing the embodiments of the present application, the user is allowed to edit the replacement relationship between the material troughs within the target material trough set at any time, thereby offering high flexibility.

With reference to the second possible implementation of the first aspect, in a third possible implementation, the material replenishment method further includes:
adjusting the replacement relationship between the material troughs within the target material trough set in response to an editing operation of the user on the replacement relationship editing interface, where the replacement relationship between the material troughs within the target material trough set includes at least one of a number of material troughs within the target material trough set and a replacement order of the material troughs within the target material trough set.

In the embodiments of the present application, the user can adjust at least one of the number of material troughs contained in the target material trough set and the replacement order of the material troughs within the target material trough set. By implementing the embodiments of the present application, the replacement relationship between the material troughs within the material trough set is editable, thereby meeting the printing requirements of different users, and offering strong applicability and high flexibility.

With reference to the third possible implementation of the first aspect, in a fourth possible implementation, adjusting the replacement relationship between the material troughs within the target material trough set in response to the editing operation of the user on the replacement relationship editing interface includes:
displaying a first function control of a target material trough in response to the user selecting the target material trough from the target material trough set; and
moving the replacement order of the target material trough within the target material trough set forward in response to a first input of the user at the first function control.

By implementing the embodiments of the present application, the replacement order of the target material trough within the target material trough set can be moved forward, thereby facilitating user operation.

With reference to the third possible implementation of the first aspect, in a fifth possible implementation, adjusting the replacement relationship between the material troughs within the target material trough set in response to the editing operation of the user on the replacement relationship editing interface includes:
displaying a first function control of a target material trough in response to the user selecting the target material trough from the target material trough set; and
moving the replacement order of the target material trough within the target material trough set backward in response to a second input of the user at the first function control.

By implementing the embodiments of the present application, the replacement order of the target material trough within the target material trough set can be moved backward, thereby facilitating user operation.

With reference to the third possible implementation of the first aspect, in a sixth possible implementation, adjusting the replacement relationship between the material troughs within the target material trough set in response to the editing operation of the user on the replacement relationship editing interface includes:
displaying a first function control of a target material trough in response to the user selecting the target material trough from the target material trough set; and
removing the target material trough from the target material trough set in response to a third input of the user at the first function control.

By implementing the embodiments of the present application, the target material trough can be removed from the target material trough set, thereby facilitating user operation.

With reference to the third possible implementation of the first aspect, in a seventh possible implementation, adjusting the replacement relationship between the material troughs within the target material trough set in response to the editing operation of the user on the replacement relationship editing interface includes:
displaying a first function control of a target material trough in response to the user selecting the target material trough from the target material trough set; and
exiting the replacement relationship editing interface of the target material trough set in response to a fourth input of the user at the first function control.

By implementing the embodiments of the present application, exiting from the replacement relationship editing interface of the target material trough set is allowed, thereby facilitating user operation.

With reference to the second possible implementation of the first aspect, in an eighth possible implementation, a second function control is displayed on the replacement relationship editing interface; and
the material replenishment method further includes:
displaying at least one addable material trough in a first style in response to an input operation of the user at the second function control; and
adding a target addable material trough to the target material trough set in response to the user selecting the target addable material trough from the at least one addable material trough.

By implementing the embodiments of the present application, the addable material trough can be added to the target material trough set, thereby increasing the number of material troughs within the target material trough set.

Further, a non-addable material trough is displayed in a second style. In terms of material type, the printing material in the non-addable material trough does not match the printing material in the material troughs within the target material trough set. By displaying the addable material trough and the non-addable material trough in different display styles, it is possible to avoid selecting the printing material that does not match the material troughs within the target material trough set.

With reference to the second possible implementation of the first aspect to the eighth possible implementation of the first aspect, in a ninth possible implementation, a third function control is displayed on the replacement relationship editing interface; and
the material replenishment method further includes:
canceling the replacement relationship between the material troughs within the target material trough set in response to an input operation of the user at the third function control.

By implementing the embodiments of the present application, the third function control can be used to cancel the replacement relationship between the material troughs within the target material trough set with a single click, thereby saving operation time of the user.

With reference to the first aspect or with reference to any one of the above possible implementations of the first aspect, in a tenth possible implementation, before displaying the at least one material trough set, the material replenishment method further includes:
acquiring attribute information of the printing materials provided in all material troughs of the automatic feeding system, and obtaining the at least one material trough set based on the attribute information of the printing materials.

By implementing the embodiments of the present application, there is no need for the user to input the attribute information of the printing material in the material trough. Instead, such attribute information is automatically identified by the machine, thereby achieving intelligent identification. The material trough set may be displayed before or during printing, and thus the attribute information of the printing material may also be acquired before or during printing; that is, the attribute information of the printing material may be acquired at any time. This also allows new printing materials added by the user during printing to be identified.

With reference to the first aspect or with reference to any one of the above possible implementations of the first aspect, in an eleventh possible implementation, before displaying the at least one material trough set, the material replenishment method further includes:
displaying a material editing interface of each material trough of the automatic feeding system;
obtaining, based on an input operation of the user on the material editing interface of each material trough, attribute information of the printing materials provided in all material troughs of the automatic feeding system; and
obtaining the at least one material trough set based on the attribute information of the printing materials.

In the embodiments of the present application, the attribute information of the printing material provided in each material trough is edited by the user. By implementing the embodiments of the present application, there is no need to wait for machine identification, thereby saving time. The material editing interface may also be displayed before or during printing, and thus the attribute information of the printing material may also be edited by the user before or during printing; that is, the attribute information of the printing material may be edited at any time. This allows the user to edit the newly added printing material during printing, and also correct the attribute information of the printing material that contains editing errors in time.

An embodiment of the present application discloses a 3D printer. The 3D printer is configured to be connected to an automatic feeding system provided with a plurality of material troughs, and the 3D printer is configured to perform the material replenishment method described with reference to the first aspect or with reference to any one of the above possible implementations of the first aspect.

An embodiment of the present application discloses a 3D printing system. The 3D printing system includes a 3D printer and an automatic feeding system;
the 3D printer is configured to perform the material replenishment method described with reference to the first aspect or with reference to any one of the above possible implementations of the first aspect.

Further, in some feasible implementations, the 3D printing system further includes at least one terminal device, and the 3D printer is in communication connection with the at least one terminal device; the at least one terminal device is configured to display various display contents involved in the material replenishment method as described above, and the material trough set can be viewed and edited on multiple terminals.

An embodiment of the present application provides a terminal device. The terminal device includes a processor and a display screen. The processor can perform the material replenishment method described with reference to the first aspect or with reference to any one of the above possible implementations of the first aspect.

An embodiment of the present application discloses a computer-readable storage medium storing a computer program thereon. The computer program, when run by a processor, causes the processor to perform the material replenishment method described with reference to the first aspect or with reference to any one of the above possible implementations of the first aspect.

An embodiment of the present application discloses a computer program product including a computer program. The computer program, when run by a processor, causes the processor to perform the material replenishment method described with reference to the first aspect or with reference to any one of the above possible implementations of the first aspect.

It should be understood that for implementation and beneficial effects of the above aspects of the present application, reference may be made to each other.

### BRIEF DESCRIPTION OF THE DRAWINGS

FIG. 1 is a schematic diagram of a scenario of a 3D printing system according to an embodiment of the present application;

FIG. 2 is a schematic diagram of another scenario of a 3D printing system according to an embodiment of the present application;

FIG. 3 is a schematic flowchart of a material replenishment method for a 3D printer according to an embodiment of the present application;

FIG. 4 is a schematic diagram of a graphical user interface of a material trough set according to an embodiment of the present application;

FIG. 5 is a schematic diagram of another graphical user interface of a material trough set according to an embodiment of the present application;

FIG. 6 is another schematic flowchart of a material replenishment method for a 3D printer according to an embodiment of the present application;

FIG. 7 is a schematic diagram of a communication connection relationship according to an embodiment of the present application;

FIG. 8A is a schematic diagram of another graphical user interface of a material trough set according to an embodiment of the present application;

FIG. 8B is a schematic diagram of a replacement relationship editing interface of a target material trough set according to an embodiment of the present application;

FIG. 9A is another schematic diagram of a replacement relationship editing interface of a target material trough set according to an embodiment of the present application;

FIG. 9B is a schematic diagram of a graphical user interface of the target material trough set obtained from FIG. 9A;

FIG. 10A is another schematic diagram of a replacement relationship editing interface of a target material trough set according to an embodiment of the present application;

FIG. 10B is a schematic diagram of a graphical user interface of the target material trough set obtained from FIG. 10A;

FIG. 11A is another schematic diagram of a replacement relationship editing interface of a target material trough set according to an embodiment of the present application;

FIG. 11B is a schematic diagram of a graphical user interface of the target material trough set obtained from FIG. 11A;

FIG. 12A is another schematic diagram of a replacement relationship editing interface of a target material trough set according to an embodiment of the present application;

FIG. 12B is a schematic diagram of a graphical user interface of the target material trough set obtained from FIG. 12A;

FIG. 13A is another schematic diagram of a replacement relationship editing interface of a target material trough set according to an embodiment of the present application;

FIG. 13B is a schematic diagram of a graphical user interface of the material trough set obtained from FIG. 13A;

FIG. 14A is another schematic diagram of a replacement relationship editing interface of a target material trough set according to an embodiment of the present application; and

FIG. 14B is a schematic diagram of a graphical user interface of the material trough set obtained from FIG. 14A.

### DETAILED DESCRIPTION

Embodiments of the present application will be further described in detail below with reference to the accompanying drawings.

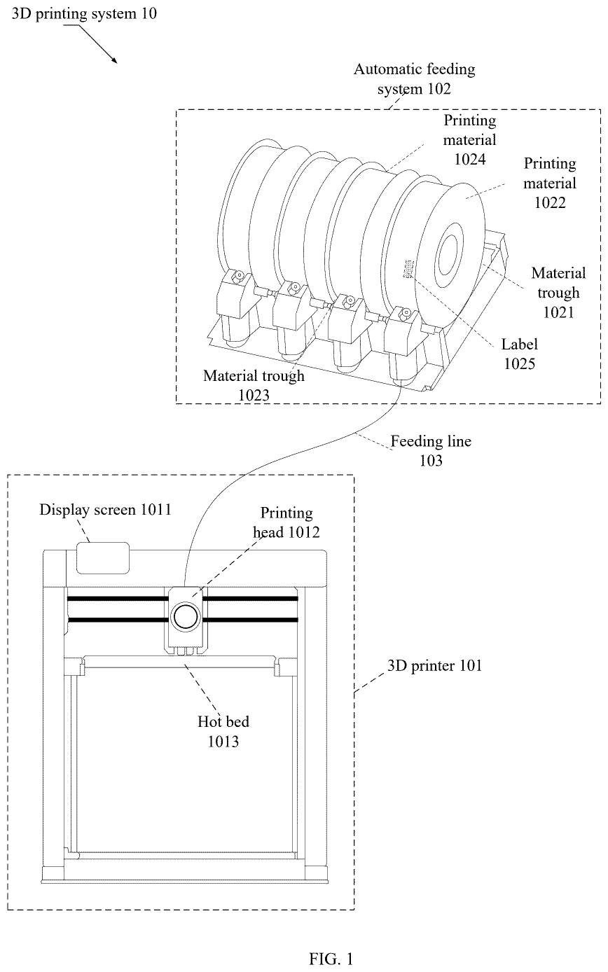

In some feasible implementations, referring to FIG. 1, FIG. 1 is a schematic diagram of a scenario of a 3D printing system according to an embodiment of the present application. As shown in FIG. 1, the 3D printing system 10 may include a 3D printer 101 and an automatic feeding system 102.

The automatic feeding system 102 is provided with a plurality of material troughs, and one material trough is correspondingly provided with one printing material. For example, the material trough 1021 is correspondingly provided with a printing material 1022, and the material trough 1023 is correspondingly provided with a printing material 1024.

The 3D printer 101 includes a display screen 1011. The display screen 1011 can display a graphical user interface of the 3D printer 101, such as a replacement relationship editing interface and a material editing interface.

The 3D printer 101 further includes a printing head 1012 and a hot bed 1013. The printing head 1012 is connected to the automatic feeding system 102 via a feeding line 103. In a specific implementation, the automatic feeding system 102 provides a printing material (for example, a printing material 1022 or a printing material 1024) to the printing head 1012, and the printing material 1022 or the printing material 1024 is heated to a molten state in the printing head. The printing head can extrude the printing material 1022 or the printing material 1024 in a molten state onto a print panel while moving along a printing path of the 3D printer 101, thereby printing a three-dimensional object layer by layer. The print panel is disposed on a side of the hot bed 1013 proximal to the printing head 1012.

Illustratively, if the material trough 1021 and the material trough 1023 belong to the same material trough set, the 3D printer 101 can display this material trough set, and, in the case that the printing material 1022 in the material trough 1021 is used up, replace the printing material 1022 with the printing material 1024 in the material trough 1023 for printing. That is, the 3D printer 101 can achieve automatic material replenishment without manual intervention.

In one embodiment, the printing material is provided with a label. For example, the printing material 1022 is provided with a label 1025, and the label 1025 carries attribute information of the printing material 1022, such as material manufacturer, material type, material color, and printing temperature. The material type may be, for example, polylactic acid (PLA), acrylonitrile butadiene styrene (ABS) copolymer, poly(ethylene terephthalateco-1,4-cylclohexylenedim ethylene terephthalate), or thermoplastic polyurethane elastomer (TPU).

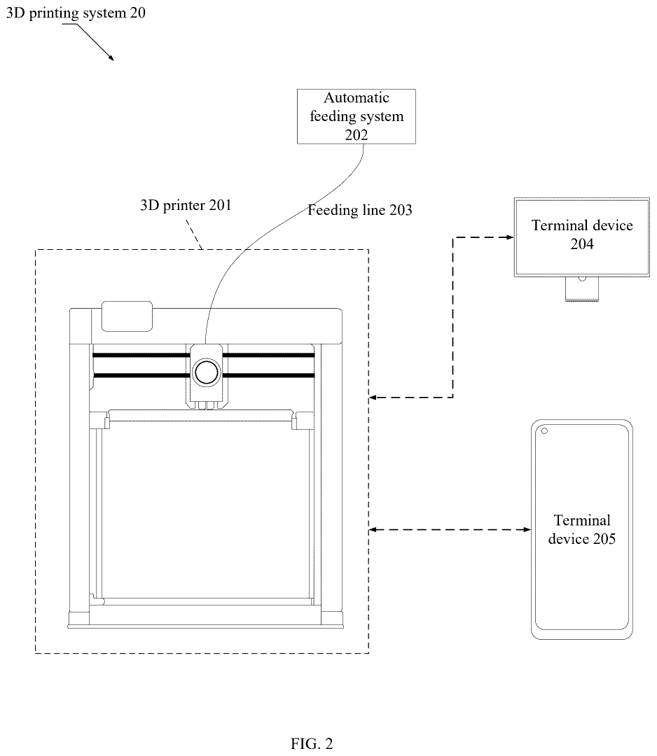

In one embodiment, in some feasible implementations, referring to FIG. 2, FIG. 2 is a schematic diagram of another scenario of a 3D printing system according to an embodiment of the present application. As shown in FIG. 2, the 3D printing system 20 may include a 3D printer 201, an automatic feeding system 202, and at least one terminal device (for example, a terminal device 204 or a terminal device 205).

For the specific implementation of the automatic feeding system 202, reference may be made to the automatic feeding system 102 shown in FIG. 1, which will not be repeated here.

The 3D printer 201 is connected to the automatic feeding system 202 via a feeding line 203. Different from the 3D printing system 10 shown in FIG. 1, in the 3D printing system 20 according to the embodiments of the present application, the 3D printer 201 is further in communication connection with at least one terminal device.

Illustratively, the 3D printer 201 may establish communication connections with each terminal device via local area network, WIFI, or Bluetooth. In one embodiment, the 3D printer 201 may establish communication with each terminal device via a cloud server (not shown).

Illustratively, the terminal device 204 and the terminal device 205 may be in one embodiment implemented as a desktop computer, a laptop computer, a tablet computer, a smart display, a mobile phone terminal, or a display module in the 3D printer. The terminal device 204 or the terminal device 205 may display the graphical user interface displayed on the display screen of the 3D printer 201, such as a replacement relationship editing interface and a material editing interface.

In the embodiments of the present application, the 3D printer 201 can still achieve automatic material replenishment without manual intervention.

The following describes in detail how the 3D printer achieves automatic material replenishment with reference to the accompanying drawings.

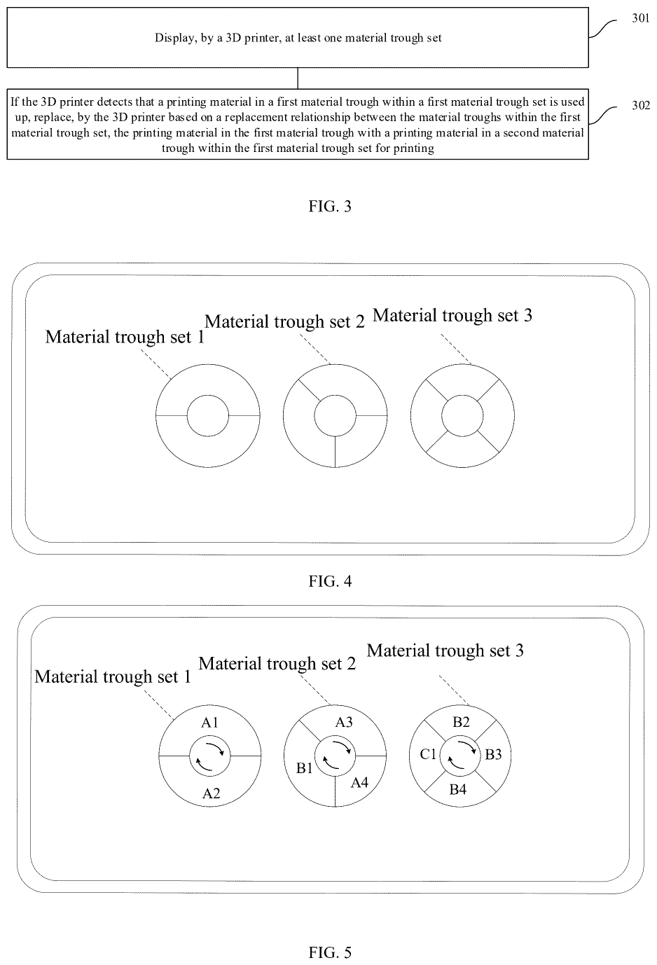

Referring to FIG. 3, FIG. 3 is a schematic flowchart of a material replenishment method for a 3D printer according to an embodiment of the present application. As shown in FIG. 3, the material replenishment method for the 3D printer may in one embodiment include the following steps:

In step 301, a 3D printer displays at least one material trough set. Each material trough set includes at least two material troughs, and a replacement relationship exists between the material troughs within each material trough set.

In a specific implementation, the 3D printer is provided with a display screen, and at least one material trough set is displayed on the display screen. Illustratively, the display screen of the 3D printer may only display the material trough set itself. In this case, as shown in FIG. 4, the display screen of the 3D printer may display a material trough set 1, a material trough set 2, and a material trough set 3.

In one embodiment, the display screen of the 3D printer may in one embodiment display at least two material troughs within the material trough set and the replacement relationship between the at least two material troughs. In this case, as shown in FIG. 5, the display screen of the 3D printer may display that the material trough set 1 includes a material trough A1 and a material trough A2; the material trough set 2 includes a material trough A3, a material trough A4, and a material trough B1; and the material trough set 3 includes a material trough B2, a material trough B3, a material trough B4, and a material trough C1. Illustratively, in FIG. 5, the clockwise arrow indicates a replacement order in the replacement relationship. For example, in the material trough set 2, the replacement order is A3, A4, B1. Thus, in the case that the printing material in the material trough A3 is used up, the 3D printer can replace the printing material in the material trough A3 with the printing material in the material trough A4 for printing; in the case that the printing material in the material trough A4 is used up, the 3D printer can replace the printing material in the material trough A4 with the printing material in the material trough B1 for printing. In one embodiment, in the case that the printing material in the material trough B1 is used up, the 3D printer replaces the printing material in the material trough B1 with the printing material in the material trough A4 for printing; in the case that the printing material in the material trough A4 is used up, the 3D printer replaces the printing material in the material trough A4 with the printing material in the material trough A3 for printing.

Further, in some feasible implementations, the material troughs within the material trough set are displayed in a ring-shaped manner. As shown in FIGS. 4 and 5, the material troughs within each material trough set form a circular ring. In one embodiment, the material troughs within one material trough set may also be displayed in the form of a list (not shown).

In the embodiments of the present application, the user can intuitively view each material trough within the material trough set and the replacement relationship between the material troughs. Thus, the user can know which material trough provides subsequent printing material after the printing material in a material trough is used up, thereby avoiding the situation where replenishment errors can only be discovered by the user during the material replenishment of the 3D printer, which would result in damage to the printed object.

In one embodiment, in some feasible embodiments, the 3D printer is in communication connection with at least one terminal device. The at least one terminal device can display at least one material trough set; that is, the at least one terminal device can display the graphical user interface shown in FIG. 4 or 5. Illustratively, if the at least one terminal device is installed with slicing software, the at least one material trough set can be displayed on the graphical user interface of the slicing software; in one embodiment, if the at least one terminal device is installed with printing monitoring software, the at least one material trough set can be displayed on the printing monitoring software.

In one embodiment, in some feasible implementations, before step 301, the 3D printer acquires attribute information of the printing materials provided in all material troughs of the automatic feeding system. Illustratively, the 3D printer can read the label of the printing material provided in each material trough via radio-frequency identification (RFID) technology, to acquire the attribute information of the printing material correspondingly provided in each material trough. In one embodiment, the automatic feeding system identifies the attribute information of the printing material correspondingly provided in each material trough via the RFID technology, and sends the attribute information of the printing material correspondingly provided in each material trough to the 3D printer. In this case, the 3D printer or the terminal device can obtain at least one material trough set based on the attribute information of the printing material. For example, material troughs containing printing materials from the same material manufacturer or with the same material type, the same color, or the same printing temperature may be grouped into the same material trough set.

By implementing the embodiments of the present application, there is no need for the user to input the attribute information of the printing material in the material trough. Instead, such attribute information is automatically identified by the machine, thereby achieving intelligent identification. The 3D printer can display the material trough set before or during printing, and thus the 3D printer can acquire the attribute information of the printing material before or during printing; that is, the 3D printer can acquire the attribute information of the printing material at any time. This also allows new printing materials added by the user during printing to be identified.

In one embodiment, in some feasible implementations, before step 301, the 3D printer or the terminal device displays the material editing interface of each material trough of the automatic feeding system. Based on the input operation of the user on the material editing interface of each material trough, the attribute information of the printing materials provided in all material troughs of the automatic feeding system is obtained. In this case, the 3D printer or the terminal device obtains at least one material trough set based on the attribute information of the printing materials.

In the embodiments of the present application, the attribute information of the printing material provided in each material trough is edited by the user. By implementing the embodiments of the present application, there is no need to wait for machine identification, thereby saving time. The material editing interface may also be displayed before or during printing, and thus the attribute information of the printing material may also be edited by the user before or during printing; that is, the attribute information of the printing material may be edited at any time. This allows the user to edit the newly added printing material during printing, and also correct the attribute information of the printing material that contains editing errors in time.

In one embodiment, in some feasible implementations, the 3D printer or the terminal device further provides a function of adding material trough sets. Illustratively, if a material trough set cannot be obtained based on the attribute information of the printing material, the 3D printer can respond to the user's operation of adding at least one material trough set. In one embodiment, the 3D printer can continue to increase the number of material troughs based on the obtained at least one material trough set.

In step 302, if the 3D printer detects that a printing material in a first material trough within a first material trough set is used up, the 3D printer replaces, based on the replacement relationship between the material troughs within the first material trough set, the printing material in the first material trough with a printing material in a second material trough within the first material trough set for printing.

In the embodiments of the present application, a material trough set in the at least one material trough set may be referred to as the first material trough set, and a material trough in the first material trough set may be referred to as the first material trough.

In one embodiment, in the case that the 3D printer detects that the printing material in the first material trough within the first material trough set is used up, the terminal device can also, based on the replacement relationship between the material troughs within the first material trough set, send a print instruction to the 3D printer, to instruct the 3D printer to replace the printing material in the first material trough with the printing material in the second material trough within the first material trough set for printing.

Illustratively, taking the material trough set 2 shown in FIG. 5 being the first material trough set as an example, if the first material trough is the material trough A3, the 3D printer replaces the printing material in the material trough A3 with the printing material in the material trough A4 for printing when the 3D printer detects that the printing material in the material trough A3 is used up.

In the embodiments of the present application, the material trough set may be intuitively displayed, and a replacement relationship exists between the material troughs within each material trough set. In the case that the printing material in the first material trough is used up, the second material trough in the same first material trough set as the first material trough can automatically replenish the printing material. By implementing the embodiments of the present application, the 3D printer can achieve automatic material replenishment without manual intervention, thereby offering convenient and fast operation, good user experience, and high printing efficiency.

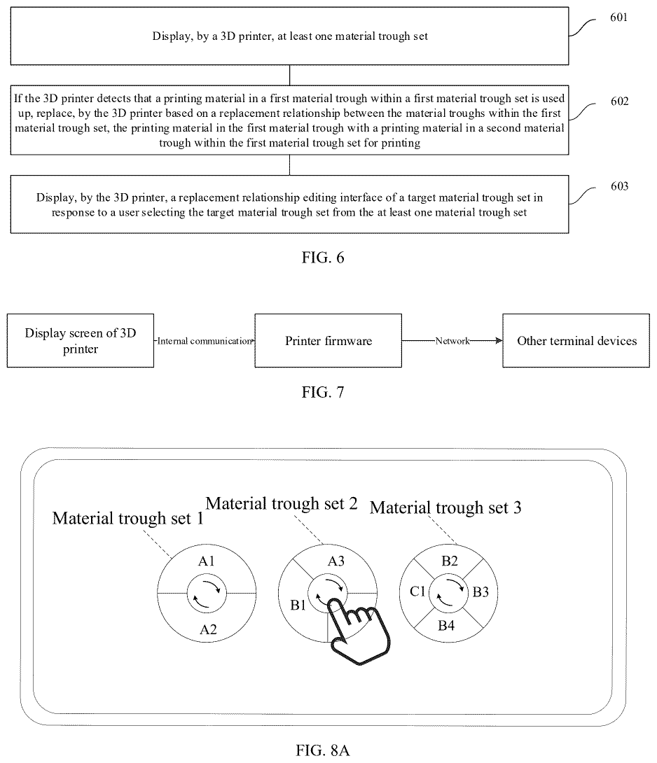

Referring to FIG. 6, FIG. 6 is another schematic flowchart of a material replenishment method for a 3D printer according to an embodiment of the present application. As shown in FIG. 6, the material replenishment method for the 3D printer may in one embodiment include the following steps:

In step 601, a 3D printer displays at least one material trough set. Each material trough set includes at least two material troughs, and a replacement relationship exists between the material troughs within each material trough set.

For the specific implementation of step 601, reference may be made to the embodiments described above with reference to FIGS. 3 to 5. In this case, the display screen of the 3D printer may also display as shown in FIG. 4 or 5, which will not be repeated here.

Illustratively, the 3D printer is provided with a printer firmware. The printer firmware is a program written into a memory and can be run by a processor in the printer, to generate the replacement relationship between the material troughs and edit the replacement relationship. In addition, the generated or edited replacement relationship between the material troughs may be stored in the printer firmware. The replacement relationship between the material troughs stored in the printer firmware can be transmitted to each display terminal via a communication protocol. The replacement relationship between the material troughs in the printer firmware can be transmitted to the display screen of the 3D printer via an internal communication protocol, while for other terminal devices, the transmission can be carried out via a network, and the communication connection relationship may be as shown in FIG. 7.

In one embodiment, in some feasible implementations, before step S601, the 3D printer acquires attribute information of the printing materials provided in all material troughs of the automatic feeding system. Illustratively, the 3D printer can read the label of the printing material provided in each material trough via RFID technology, to acquire the attribute information of the printing material correspondingly provided in each material trough. In one embodiment, the automatic feeding system identifies the attribute information of the printing material correspondingly provided in each material trough via the RFID technology, and sends the attribute information of the printing material correspondingly provided in each material trough to the 3D printer. In this case, the 3D printer can obtain at least one material trough set based on the attribute information of the printing material. For example, material troughs containing printing materials from the same material manufacturer or with the same material type, the same color, or the same printing temperature may be grouped into the same material trough set.

By implementing the embodiments of the present application, there is no need for the user to input the attribute information of the printing material in the material trough. Instead, such attribute information is automatically identified by the machine, thereby achieving intelligent identification.

In one embodiment, in some feasible implementations, before step S601, the 3D printer or the terminal device displays the material editing interface of each material trough of the automatic feeding system. Based on the input operation of the user on the material editing interface of each material trough, the attribute information of the printing materials provided in all material troughs of the automatic feeding system is obtained. In this case, the 3D printer obtains at least one material trough set based on the attribute information of the printing materials.

In the embodiments of the present application, the attribute information of the printing material provided in each material trough is edited by the user. By implementing the embodiments of the present application, there is no need to wait for machine identification, thereby saving time.

In step 602, if the 3D printer detects that a printing material in a first material trough within a first material trough set is used up, the 3D printer replaces, based on the replacement relationship between the material troughs within the first material trough set, the printing material in the first material trough with a printing material in a second material trough within the first material trough set for printing.

For the specific implementation of step 602, reference may be made to the embodiments described above with reference to FIGS. 3 to 5, which will not be repeated here.

In step 603, in response to the user selecting a target material trough set from the at least one material trough set, the 3D printer or the terminal device displays a replacement relationship editing interface of the target material trough set.

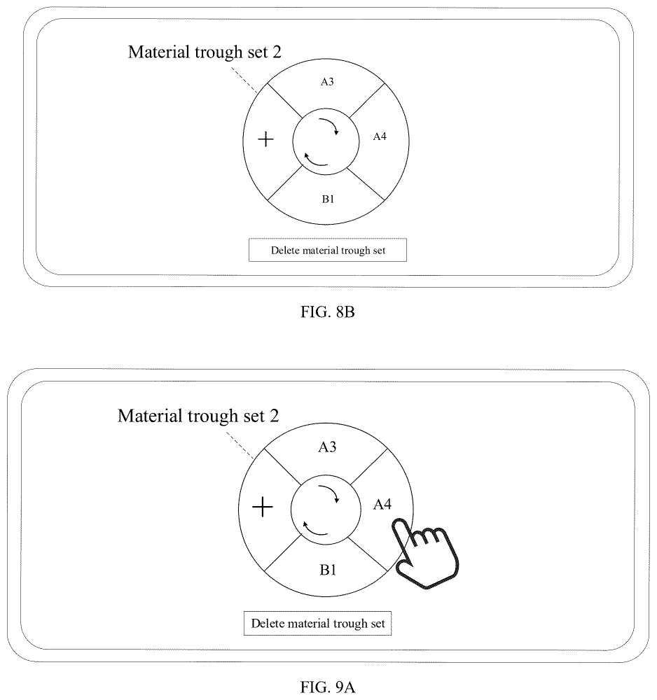

In the embodiments of the present application, the user can select, by clicking, the target material trough set from the at least one material trough set. As shown in FIG. 8A, the user may click and select the material trough set 2. In this case, the target material trough set is the material trough set 2, and the 3D printer or the terminal device displays the replacement relationship editing interface of the material trough set 2. Illustratively, the replacement relationship editing interface of the material trough set 2 may be as shown in FIG. 8B.

In one embodiment, the user may also select the target material trough set from the at least one material trough set by means of text input. The embodiments of the present application do not impose any limitation on how the user selects the target material trough set. The schematic diagram of FIG. 8A should be understood as an example, and constitutes no limitation on the embodiments of the present application.

Further, in some feasible implementations, the 3D printer may, in response to the editing operation of the user on the replacement relationship editing interface, adjust the replacement relationship between the material troughs within the target material trough set. The replacement relationship between the material troughs within the target material trough set includes at least one of the number of material troughs within the target material trough set and the replacement order of the material troughs within the target material trough set.

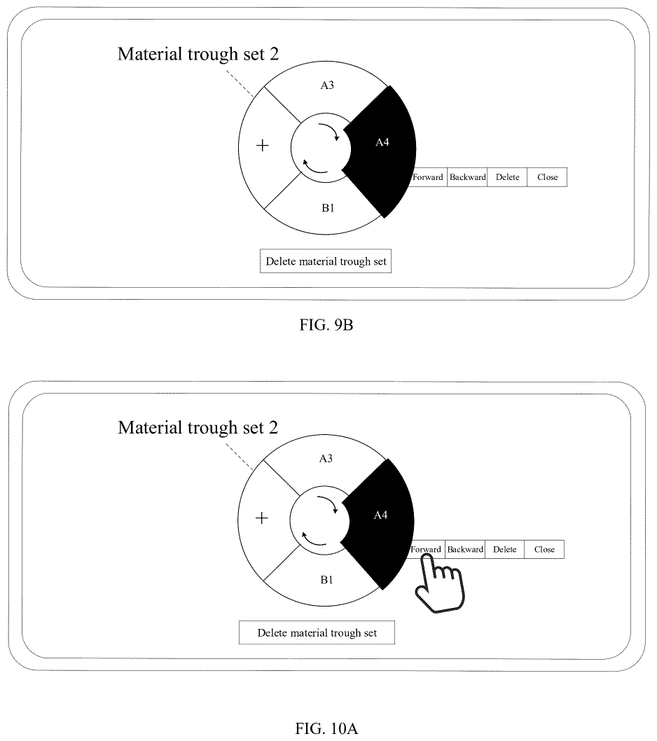

Illustratively, the following describes, by way of exemplary explanation with reference to FIGS. 9A to 11B, the adjustment of the replacement order between the material troughs within the target material trough set.

In some feasible implementations, the 3D printer may, in response to the user selecting the target material trough from the target material trough set, display a first function control of the target material trough.

Illustratively, as shown in FIG. 9A, the user may click the material trough A4 within the material trough set 2. In this case, the target material trough is the material trough A4, and the 3D printer or the terminal device displays the first function control of the material trough A4. Illustratively, the first function control of the material trough A4 may be as shown in FIG. 9B. The first function control has the functions of moving the target material trough forward and backward and deleting the target material trough from the material trough set.

In one embodiment, the first function control may be displayed in the form of a pop-up window, or may be displayed in the form of a text box, or may be displayed in the form of a list. That is, the display form of the first function control is not limited in the embodiments of the present application.

In one embodiment, the 3D printer can highlight the area of the target material trough in black, bold, or the like to distinguish the target material trough from other material troughs within the material trough set, thereby making it easier for the user to identify and improving the user experience.

In one embodiment, the selection operation of selecting any target material trough from the target material trough set may also be performed on at least one terminal device communicatively connected to the 3D printer. That is, the terminal device may also display the interfaces in FIGS. 9A and 9B.

In some feasible implementations, the 3D printer, in response to a first input of the user at the first function control, moves the replacement order of the target material trough within the target material trough set forward. In a specific implementation, the first input of the user at the first function control may be inputting text such as “Forward” or “Move Forward”, or clicking option boxes such as “Forward” or “Move Forward”, or dragging the target material trough, or the like. The first input of the user at the first function control is not limited in the embodiments of the present application.

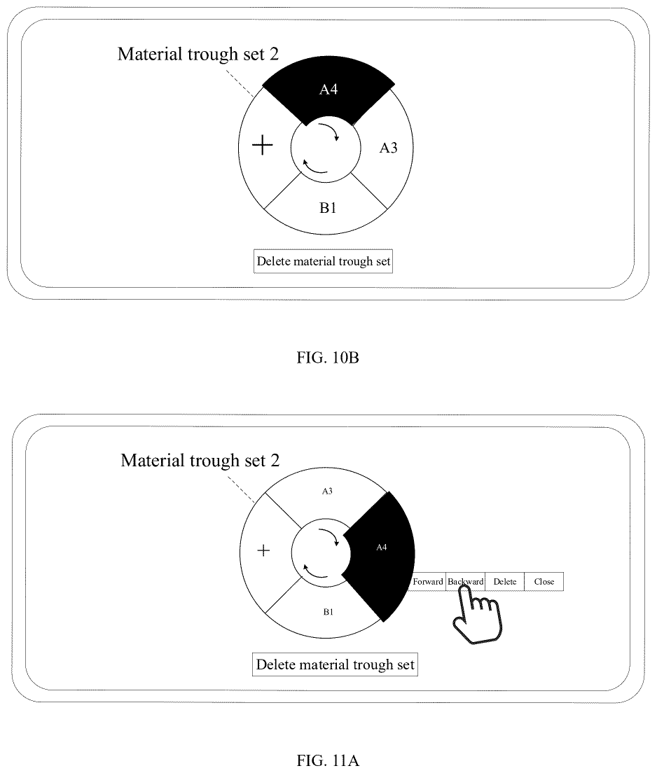

Illustratively, as shown in FIG. 10A, taking the first function control displayed in the form of a pop-up window as an example, the user clicks the “Forward” pop-up box at the first function control of the material trough A4 to move the replacement order of the material trough A4 forward. In this case, the replacement relationship editing interface of the material trough set 2 is as shown in FIG. 10B. The display position of the material trough A4 is moved forward, and the replacement order in the material trough set 2 is changed from A3, A4, B1 to A4, A3, B1. Thus, in the case that the printing material in the material trough A4 is used up, the 3D printer can replace the printing material in the material trough A4 with the printing material in the material trough A3 for printing; in the case that the printing material in the material trough A3 is used up, the 3D printer can replace the printing material in the material trough A3 with the printing material in the material trough B1 for printing. In one embodiment, in the case that the printing material in the material trough B1 is used up, the 3D printer replaces the printing material in the material trough B1 with the printing material in the material trough A3 for printing; in the case that the printing material in the material trough A3 is used up, the 3D printer replaces the printing material in the material trough A3 with the printing material in the material trough A4 for printing. It should be noted that the 3D printer may start printing from the printing material in the material trough A3, or start printing from the printing material in the material trough B1. The starting printing material of the 3D printer is not limited in the embodiments of the present application.

Similarly, in response to the first input of the user at the first function control, the replacement order of the target material trough within the target material trough set may also be moved forward on at least one terminal device communicatively connected to the 3D printer. That is, the terminal device may also display the interfaces in FIGS. 10A and 10B.

In one embodiment, in some feasible implementations, the 3D printer, in response to a second input of the user at the first function control, moves the replacement order of the target material trough within the target material trough set backward. In a specific implementation, the second input of the user at the first function control may be inputting text such as “Backward” or “Move Backward”, or clicking option boxes such as “Backward” or “Move Backward”, or dragging the target material trough, or the like. The second input of the user at the first function control is not limited in the embodiments of the present application.

Illustratively, as shown in FIG. 11A, taking the first function control displayed in the form of a pop-up window as an example, the user clicks the “Backward” pop-up box at the first function control of the material trough A4 to move the replacement order of the material trough A4 backward. In this case, the replacement relationship editing interface of the material trough set 2 is as shown in FIG. 11B. The display position of the material trough A4 is moved backward, and the replacement order in the material trough set 2 is changed from A3, A4, B1 to A3, B1, A4. Thus, in the case that the printing material in the material trough A3 is used up, the 3D printer can replace the printing material in the material trough A3 with the printing material in the material trough B1 for printing; in the case that the printing material in the material trough B1 is used up, the 3D printer can replace the printing material in the material trough B1 with the printing material in the material trough A4 for printing. In one embodiment, in the case that the printing material in the material trough A4 is used up, the 3D printer can replace the printing material in the material trough A4 with the printing material in the material trough B1 for printing; in the case that the printing material in the material trough B1 is used up, the 3D printer can replace the printing material in the material trough B1 with the printing material in the material trough A3 for printing. It should be noted that the 3D printer may start printing from the printing material in the material trough B1, or start printing from the printing material in the material trough A4. The starting printing material of the 3D printer is not limited in the embodiments of the present application.

Similarly, in response to the second input of the user at the first function control, the replacement order of the target material trough within the target material trough set may also be moved backward on at least one terminal device communicatively connected to the 3D printer. That is, the terminal device may also display the interfaces in FIGS. 11A and 11B.

In one embodiment, in some feasible implementations, the 3D printer, in response to a third input of the user at the first function control, removes the target material trough from the target material trough set. In a specific implementation, the third input of the user at the first function control may be inputting text such as “Delete” or “Remove”, or clicking option boxes such as “Delete” or “Remove”, or dragging the target material trough, or the like. The third input of the user at the first function control is not limited in the embodiments of the present application.

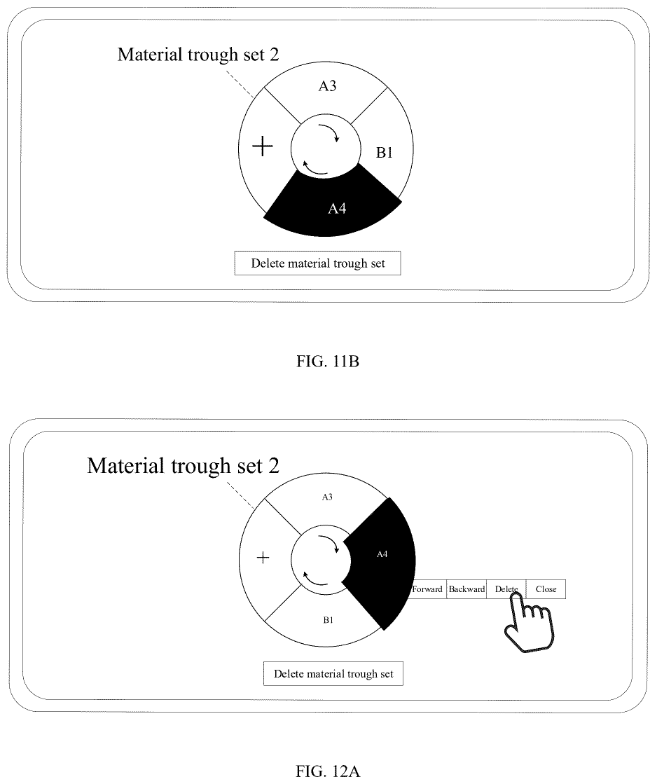

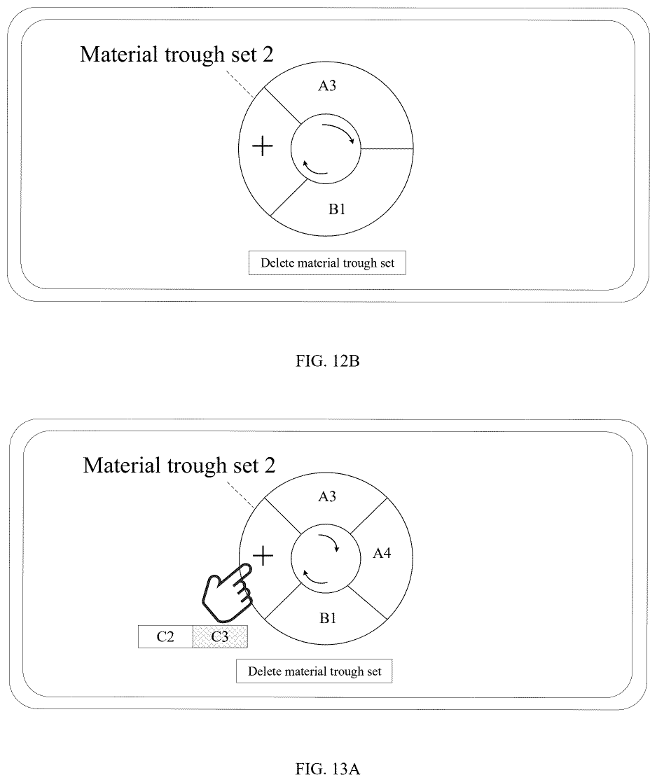

Illustratively, as shown in FIG. 12A, taking the first function control displayed in the form of a pop-up window as an example, the user clicks the “Delete” pop-up box at the first function control of the material trough A4 to remove the material trough A4 from the material trough set 2. In this case, the replacement relationship editing interface of the material trough set 2 is as shown in FIG. 12B. The material trough A4 is deleted from the material trough set 2, and the replacement order in the material trough set 2 is changed from A3, A4, B1 to A3, B1. Thus, in the case that the printing material in the material trough A3 is used up, the 3D printer can replace the printing material in the material trough A3 with the printing material in the material trough B1 for printing. In one embodiment, in the case that the printing material in the material trough B1 is used up, the 3D printer replaces the printing material in the material trough B1 with the printing material in the material trough A3 for printing.

Similarly, in response to the third input of the user at the first function control, the removal of the target material trough from the target material trough set may also be performed on at least one terminal device communicatively connected to the 3D printer. That is, the terminal device may also display the interfaces in FIGS. 12A and 12B.

In one embodiment, in some feasible implementations, the 3D printer, in response to a fourth input of the user at the first function control, exits the replacement relationship editing interface of the target material trough set. In this case, the modification of the replacement relationship between the material troughs within the target material trough set is exited.

In a specific implementation, the fourth input of the user at the first function control may be inputting text such as “Close”or “Exit”or clicking option boxes such as “Close”or “Exit”. The fourth input of the user at the first function control is not limited in the embodiments of the present application.

In one embodiment, in some feasible implementations, a second function control is displayed on the replacement relationship editing interface. The 3D printer, in response to an input operation of the user at the second function control, displays at least one addable material trough in a first style. The 3D printer, in response to the user selecting a target addable material trough from the at least one addable material trough, adds the target addable material trough to the target material trough set.

By implementing the embodiments of the present application, the addable material trough can be added to the target material trough set, thereby increasing the number of material troughs within the target material trough set.

Further, a non-addable material trough is displayed in a second style. In terms of material type, the printing material in the non-addable material trough does not match the printing material in the material troughs within the target material trough set. By displaying the addable material trough and the non-addable material trough in different display styles, it is possible to avoid selecting the printing material that does not match the material troughs within the target material trough set.

In one embodiment, the second function control may be displayed in the form of a pop-up window, or may be displayed in the form of a text box, or may be displayed in the form of a list. That is, the display form of the second function control is not limited in the embodiments of the present application.

In one embodiment, the input operation of the user at the second function control may be inputting text or characters such as “Add” or “+” or clicking option boxes such as “Add” or “+”. The input operation of the user at the second function control is not limited in the embodiments of the present application.

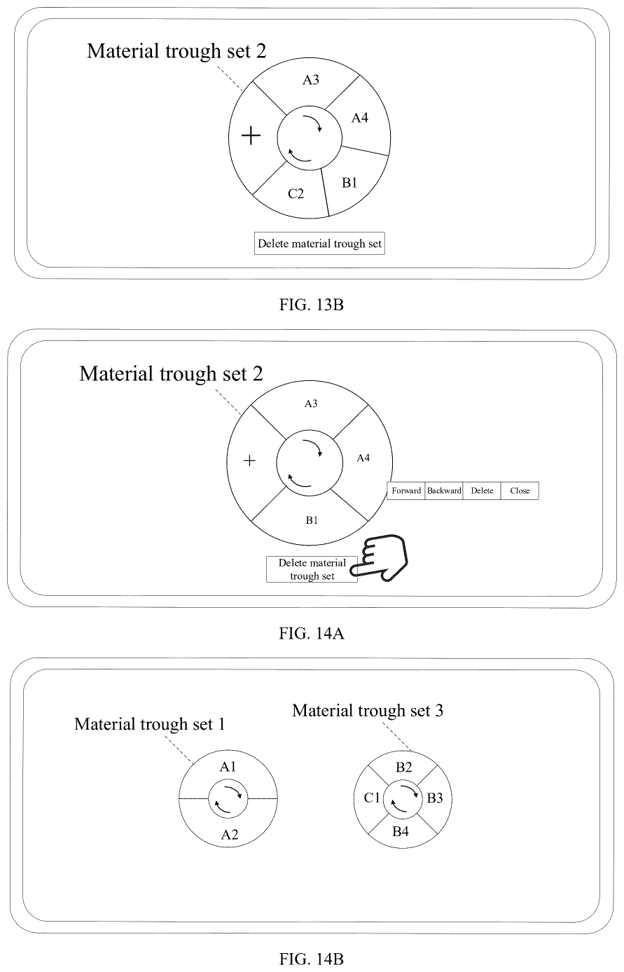

Illustratively, as shown in FIG. 13A, taking the second function control displayed in the form of a ring-shaped control as an example, the user clicks the “+” pop-up box at the second function control of the material trough set 2. In this case, an addable material trough C2 and a non-addable material trough C3 are displayed on the replacement relationship editing interface of the material trough set 2, and the display styles of the addable material trough C2 and the non-addable material trough C3 are different. The user may click the addable material trough C2 and add the addable material trough C2 to the material trough set 2. In this case, the replacement relationship editing interface of the material trough set 2 is as shown in FIG. 13B. The material trough C2 is newly added in the material trough set 2, and the replacement order in the material trough set 2 is changed from A3, A4, B1 to A3, A4, B1, C2. Thus, in the case that the printing material in the material trough A3 is used up, the 3D printer can replace the printing material in the material trough A3 with the printing material in the material trough A4 for printing; in the case that the printing material in the material trough A4 is used up, the 3D printer can replace the printing material in the material trough A4 with the printing material in the material trough B1 for printing; in the case that the printing material in the material trough B1 is used up, the 3D printer can replace the printing material in the material trough B1 with the printing material in the material trough C2 for printing. In one embodiment, in the case that the printing material in the material trough C2 is used up, the 3D printer can replace the printing material in the material trough C2 with the printing material in the material trough B1 for printing; in the case that the printing material in the material trough B1 is used up, the 3D printer can replace the printing material in the material trough B1 with the printing material in the material trough A4 for printing; in the case that the printing material in the material trough A4 is used up, the 3D printer can replace the printing material in the material trough A4 with the printing material in the material trough A3 for printing. It should be noted that the 3D printer may start printing from the printing material in the material trough A4, or start printing from the printing material in the material trough B1. The starting printing material of the 3D printer is not limited in the embodiments of the present application.

Further, if the user clicks the non-addable material trough C3, a prompt indicating that it cannot be added may be displayed. In one embodiment, a confirmation regarding whether the user continues to add the non-addable material trough C3 may be further added under the prompt. If the user further confirms to continue adding the non-addable material trough C3, the non-addable material trough C3 is then added to the material trough set 2, thereby further improving the flexibility of editing the replacement relationship of the material trough set.

Similarly, the embodiments of the present application may also be performed on at least one terminal device communicatively connected to the 3D printer. That is, the terminal device may also display the interfaces in FIGS. 13A and 13B.

In one embodiment, in some feasible implementations, a third function control is displayed on the replacement relationship editing interface. The 3D printer, in response to an input operation of the user at the third function control, cancels the replacement relationship between the material troughs within the target material trough set.

In one embodiment, the third function control may be displayed in the form of a pop-up window, or may be displayed in the form of a text box, or may be displayed in the form of a list. That is, the display form of the third function control is not limited in the embodiments of the present application.

In one embodiment, the input operation of the user at the third function control may be inputting text such as “Delete Material Trough Set” or “Delete Replacement Relationship”, or clicking option boxes such as “Delete Material Trough Set” or “Delete Replacement Relationship”, or dragging the target material trough set, or the like. The input operation of the user at the third function control is not limited in the embodiments of the present application.

Illustratively, as shown in FIG. 14A, taking the third function control displayed in the form of a pop-up window as an example, the user clicks the “Delete Material Trough Set” pop-up box at the third function control of the material trough set 2 to delete the entire material trough set 2 and simultaneously cancel the replacement relationship among the material trough A3, the material trough A4, and the material trough B1 within the material trough set 2. In this case, the display of the material trough set changes from FIG. 5 to 14B; that is, the material trough set 2 is deleted from the material trough set 1, the material trough set 2, and the material trough set 3.

Similarly, the embodiments of the present application may also be performed on at least one terminal device communicatively connected to the 3D printer. That is, the terminal device may also display the interfaces in FIGS. 14A and 14B.

In the embodiments of the present application, the material trough set may be intuitively displayed, and a replacement relationship exists between the material troughs within each material trough set. In the case that the printing material in the first material trough is used up, the second material trough in the same first material trough set as the first material trough can automatically replenish the printing material. By implementing the embodiments of the present application, the 3D printer can achieve automatic material replenishment without manual intervention, thereby offering convenient and fast operation, good user experience, and high printing efficiency.

The present application provides a user-oriented human-computer interaction interface, through which the user can intuitively view the replacement relationship between the material troughs in each material trough set, thereby enabling timely identification of problems during abnormal material replenishment. The present application allows the replacement relationship between the material troughs to be edited at any time. In the present application, after the attribute information of the printing materials provided in all material troughs of the automatic feeding system is determined, at least one material trough set can be obtained based on the attribute information of the printing materials, and the at least one material trough set can be displayed. The present application enables synchronous display of the material trough set across different terminals via the network, allowing the user to edit and check the replacement relationship between the material troughs at any time on multiple terminals.

It should be noted that, for simplicity in describing the method embodiments, they are expressed as a series of combined actions. However, it should be understood that the embodiments of the present application are not limited by the described action sequence.

According to the embodiments of the present application, certain steps may be performed in a different order or simultaneously. Further, it should also be learned that the embodiments described in the specification are all only some embodiments. The actions involved are not necessarily essential to the embodiments of the present application.

The present application further provides a computer-readable storage medium storing a computer program thereon. The computer program, when run by a processor, causes the processor to perform the embodiments described above with reference to FIGS. 3 to 14B.

The present application further provides a computer program product including a computer program. The computer program, when run by a processor, causes the processor to perform the embodiments described above with reference to FIGS. 3 to 14B.

The processor may be a micro control unit (MCU), a central processing unit (CPU), another general-purpose processor, a digital signal processor (DSP), an application specific integrated circuit (ASIC), a field-programmable gate array (FPGA), another programmable logic device, a discrete gate or a transistor logic device, a discrete hardware assembly, or the like.

In the embodiments of the present application, “at least one” refers to one or more. For example, at least one of a, b, and c may represent a; b; c; a and b; a and c; b and c; or a, b, and c, where a, b, and c may be singular or plural.

It should be noted that the above relational terms such as “first” and “second” are merely used to distinguish one entity or operation from another entity or operation, and should not be construed as requiring or implying any actual relationship or order between such entities or operations, nor should they be construed as indicating or implying the relative importance.

The above descriptions are specific embodiments of the present application. However, the protection scope of the present application is not limited to this. Any variations or substitutions that can easily think of within the technical scope disclosed in the present application should be included within the protection scope of the present application. Therefore, the protection scope of the present application should be subject to the protection scope defined by the claims.

What is claimed is:

1. A material replenishment method for a 3D printer, wherein the 3D printer is configured to be connected to an automatic feeding system provided with a plurality of material troughs, and the material replenishment method comprises:
acquiring attribute information of the printing materials provided in all material troughs of the automatic feeding system, and obtaining the at least one material trough set based on the attribute information of the printing materials;
displaying at least one material trough set, and display the replacement relationship of each material trough in the said material trough set; wherein each of the at least one material trough set comprises at least two material troughs, and a replacement relationship exists between the material troughs within each material trough set; the said replacement relationship is used to indicate the material trough that shall replace it for printing when the printing material in a certain material trough is exhausted; and
the at least one material trough set comprises a first material trough set; and if a printing material in a first material trough within the first material trough set is detected to be used up, replacing, based on a replacement relationship between the material troughs within the first material trough set, the printing material in the first material trough with a printing material in a second material trough within the first material trough set for printing.

2. The material replenishment method according to claim 1, further comprising:
displaying at least one of the said material trough sets composed of material troughs holding printing materials of the same material type, color or printing temperature.

3. The material replenishment method according to claim 1, further comprising:
the material troughs within the material trough set are displayed in a ring-shaped manner.

4. The material replenishment method according to claim 1, further comprising:
The replacement relationship between the material troughs can be transmitted to each display terminal.

5. The material replenishment method according to claim 1, further comprising:
displaying a replacement relationship editing interface of a target material trough set in response to a user selecting the target material trough set from the at least one material trough set.

6. The material replenishment method according to claim 5, further comprising:
adjusting a replacement relationship between the material troughs within the target material trough set in response to an editing operation of the user on the replacement relationship editing interface, wherein the replacement relationship between the material troughs within the target material trough set comprises at least one of a number of material troughs within the target material trough set and a replacement order of the material troughs within the target material trough set.

7. The material replenishment method according to claim 6, wherein adjusting the replacement relationship between the material troughs within the target material trough set in response to the editing operation of the user on the replacement relationship editing interface comprises:
displaying a first function control of a target material trough in response to the user selecting the target material trough from the target material trough set; and
moving the replacement order of the target material trough within the target material trough set forward in response to a first input of the user at the first function control.

8. The material replenishment method according to claim 6, wherein adjusting the replacement relationship between the material troughs within the target material trough set in response to the editing operation of the user on the replacement relationship editing interface comprises:
displaying a first function control of a target material trough in response to the user selecting the target material trough from the target material trough set; and
moving the replacement order of the target material trough within the target material trough set backward in response to a second input of the user at the first function control.

9. The material replenishment method according to claim 6, wherein adjusting the replacement relationship between the material troughs within the target material trough set in response to the editing operation of the user on the replacement relationship editing interface comprises:
displaying a first function control of a target material trough in response to the user selecting the target material trough from the target material trough set; and
removing the target material trough from the target material trough set in response to a third input of the user at the first function control.

10. The material replenishment method according to claim 6, wherein adjusting the replacement relationship between the material troughs within the target material trough set in response to the editing operation of the user on the replacement relationship editing interface comprises:
displaying a first function control of a target material trough in response to the user selecting the target material trough from the target material trough set; and
exiting the replacement relationship editing interface of the target material trough set in response to a fourth input of the user at the first function control.

11. The material replenishment method according to claim 5 wherein a second function control is displayed on the replacement relationship editing interface; and
the material replenishment method further comprises:
displaying at least one addable material trough in a first style in response to an input operation of the user at the second function control; and
adding a target addable material trough to the target material trough set in response to the user selecting the target addable material trough from the at least one addable material trough.

12. The material replenishment method according to claim 5, wherein a third function control is displayed on the replacement relationship editing interface; and
the material replenishment method further comprises:
canceling the replacement relationship between the material troughs within the target material trough set in response to an input operation of the user at the third function control.

13. A 3D printer, wherein the 3D printer is configured to be connected to an automatic feeding system provided with a plurality of material troughs, and the 3D printer is configured to perform a material replenishment method for a 3D printer, wherein the 3D printer is configured to be connected to an automatic feeding system provided with a plurality of material troughs, and the material replenishment method comprises:
acquiring attribute information of the printing materials provided in all material troughs of the automatic feeding system, and obtaining the at least one material trough set based on the attribute information of the printing materials;
displaying at least one material trough set, and display the replacement relationship of each material trough in the said material trough set; wherein each of the at least one material trough set comprises at least two material troughs, and a replacement relationship exists between the material troughs within each material trough set; the said replacement relationship is used to indicate the material trough that shall replace it for printing when the printing material in a certain material trough is exhausted; and
the at least one material trough set comprises a first material trough set; and if a printing material in a first material trough within the first material trough set is detected to be used up, replacing, based on a replacement relationship between the material troughs within the first material trough set, the printing material in the first material trough with a printing material in a second material trough within the first material trough set for printing.

14. A 3D printing system, comprising:
a 3D printer and an automatic feeding system, wherein
the 3D printer is configured to perform a material replenishment method for a 3D printer, wherein the 3D printer is configured to be connected to an automatic feeding system provided with a plurality of material troughs, and the material replenishment method comprises:
acquiring attribute information of the printing materials provided in all material troughs of the automatic feeding system, and obtaining the at least one material trough set based on the attribute information of the printing materials;
displaying at least one material trough set, and display the replacement relationship of each material trough in the said material trough set; wherein each of the at least one material trough set comprises at least two material troughs, and a replacement relationship exists between the material troughs within each material trough set; the said replacement relationship is used to indicate the material trough that shall replace it for printing when the printing material in a certain material trough is exhausted; and
the at least one material trough set comprises a first material trough set; and if a printing material in a first material trough within the first material trough set is detected to be used up, replacing, based on a replacement relationship between the material troughs within the first material trough set, the printing material in the first material trough with a printing material in a second material trough within the first material trough set for printing.
